(19) United States
(12) Patent Application Publication
(10) Pub. No.: US 2021/0146924 A1
(43) Pub. Date: May 20, 2021

(54) SHIFT-BY-WIRE CONTROL SYSTEM

(71) Applicant: Honda Motor Co., Ltd., Tokyo (JP)

(72) Inventor: Kazunori Miyata, Wako-shi (JP)

(21) Appl. No.: 17/092,834

(22) Filed: Nov. 9, 2020

(30) Foreign Application Priority Data
Nov. 19, 2019 (JP) 2019-208404

(51) Int. Cl. B60W 30/14; B60W 50/02; B60R 16/023; B60W 50/023; G07C 5/08

(52) U.S. Cl. CPC B60W 30/143; B60W 50/0205; B60W 2520/10; B60W 50/023; G07C 5/0808; B60R 16/0232

(57) ABSTRACT

Shift-by-wire control system including: actuator driven by electric signals generated in response to operator's manipulation to change speed range; main and auxiliary power source; ECU; and electric circuit connecting power source and ECU. ECU acquires vehicle travel speed information; determining whether main power supply is abnormal and travel speed is predetermined speed or lower; controlling electric circuit to stop auxiliary power supply until it is determined that main power supply is abnormal and travel speed is predetermined speed or lower; controlling electric circuit to supply power from auxiliary power source when it is determined that main power supply is abnormal and travel speed is predetermined speed or lower; determining whether auxiliary output voltage is predetermined voltage or lower; and controlling actuator to change speed range to parking range when it is determined that auxiliary output voltage is predetermined voltage or lower during auxiliary power supply.

### CROSS-REFERENCE TO RELATED APPLICATION

This application is based upon and claims the benefit of priority from Japanese Patent Application No. 2019-208404 filed on Nov. 19, 2019, the content of which is incorporated herein by reference.

### BACKGROUND OF THE INVENTION

### Field of the Invention

This invention relates to a shift-by-wire control system configured to shift or change speed range using electric signals generated in response to operator's manipulation.

### Description of the Related Art

As apparatuses of this kind, an apparatus having auxiliary power source in addition to main power source is disclosed, for example, in Japanese Patent No. 4913567 (JP4913567B2). In the apparatus disclosed in JP4913567B2, when the main power source system fails or the like, the main power source is switched to the auxiliary power source, and when the voltage output from the auxiliary power source becomes a predetermined voltage or less, the speed range is changed to the parking range.

In the apparatus disclosed in JP4913567B2, the controller for switching the main power source to the auxiliary power source when failing is electrically connected to the auxiliary power source always. Therefore, the apparatus has room for improvement in terms of redundancy.

### SUMMARY OF THE INVENTION

An aspect of the present invention is a shift-by-wire control system, including: an actuator driven by electric signals generated in response to operator's manipulation to change a speed range; a power source including a main power source and an auxiliary power source; an electronic control unit including a microprocessor and a memory coupled to the microprocessor; and an electric circuit connecting the power source and the electronic control unit. The microprocessor is configured to perform: acquiring travel speed information of the vehicle; determining whether a main power supply from the main power source to the electronic control unit is abnormal and whether the travel speed is equal to or lower than a predetermined speed; controlling the electric circuit to stop an auxiliary power supply from the auxiliary power source to the electronic control unit until it is determined that the main power supply is abnormal and the travel speed is equal to or lower than the predetermined speed; controlling the electric circuit to supply power from the auxiliary power source to the electronic control unit when it is determined that the main power supply is abnormal and the travel speed is equal to or lower than the predetermined speed; determining whether an output voltage from the auxiliary power source is equal to or lower than a predetermined voltage; and controlling the actuator to change the speed range to a parking range when it is determined that the output voltage from the auxiliary power source is equal to or lower than the predetermined voltage during the auxiliary power supply.

Another aspect of the present invention is a shift-by-wire control system, including: an actuator driven by electric signals generated in response to operator's manipulation to change a speed range; a power source including a main power source and an auxiliary power source; an electronic control unit including a microprocessor and a memory coupled to the microprocessor; and an electric circuit connecting the power source and the electronic control unit. The microprocessor is configured to perform as: an actuator control unit configured to control the actuator; a power control unit configured to control power supply from the power source to the actuator control unit; and an information acquisition unit configured to acquire travel speed information of the vehicle. The power control unit includes: a determination unit configured to determine whether a main power supply from the main power source to the actuator control unit is abnormal and whether the travel speed acquired by the information acquisition unit is equal to or lower than a predetermined speed. The power control unit is configured to control the electric circuit to stop an auxiliary power supply from the auxiliary power source to the actuator control unit until it is determined by the determination unit that the main power supply is abnormal and the travel speed is equal to or lower than the predetermined speed, and to control the electric circuit to supply power from the auxiliary power source to the actuator control unit when it is determined by the determination unit that the main power supply is abnormal and the travel speed is equal to or lower than the predetermined speed. The determination unit is further configured to determine whether an output voltage from the auxiliary power source is equal to or lower than a predetermined voltage. The actuator control unit is configured to control the actuator to change the speed range to a parking range when it is determined by the determination unit that the output voltage from the auxiliary power source is equal to or lower than the predetermined voltage during the auxiliary power supply.

Another aspect of the present invention is a shift-by-wire control method for controlling shifting operation of a vehicle including: an actuator driven by electric signals generated in response to operator's manipulation to change a speed range; a power source including a main power source and an auxiliary power source; and an electric circuit connecting the power source and the actuator. The electric circuit includes an actuator control circuit configured to control the actuator. The shift-by-wire control method includes: acquiring travel speed information of the vehicle; determining whether a main power supply from the main power source to the actuator control circuit is abnormal and whether the travel speed is equal to or lower than a predetermined speed; controlling the electric circuit to stop an auxiliary power supply from the auxiliary power source to the actuator control circuit until it is determined that the main power supply is abnormal and the travel speed is equal to or lower than the predetermined speed; controlling the electric circuit to supply power from the auxiliary power source to the actuator control circuit when it is determined that the main power supply is abnormal and the travel speed is equal to or lower than the predetermined speed; determining whether an output voltage from the auxiliary power source is equal to or lower than a predetermined voltage; and controlling the actuator to change the speed range to a parking range when it is determined that the output voltage from the auxiliary power source is equal to or lower than the predetermined voltage during the auxiliary power supply.

### BRIEF DESCRIPTION OF THE DRAWINGS

The objects, features, and advantages of the present invention will become clearer from the following description of embodiments in relation to the attached drawings, in which:

FIG. 1 is a diagram schematically showing main configuration of a vehicle, on which a shift-by-wire control system according to an embodiment of the present invention is mounted;

FIG. 2 is an electric circuit diagram schematically showing main configuration of the shift-by-wire control system according to the present embodiment;

FIG. 3 is a flowchart showing an example of discharge permission process in a shift-by-wire ECU in FIG. 2;

FIG. 4 is a flowchart showing an example of discharge process in an auxiliary power source ECU in FIG. 2;

FIG. 5 is a flowchart showing an example of parking range shift process in the shift-by-wire ECU in FIG. 2;

FIG. 6 is a flowchart showing an example of charge abnormality determination process in the auxiliary power source ECU in FIG. 2;

FIG. 7 is a flowchart showing an example of parking range fix process in the shift-by-wire ECU in FIG. 2;

FIG. 8 is a flowchart showing an example of auxiliary power source capacitor degradation determination process in the auxiliary power source ECU in FIG. 2;

FIG. 9A is a graph showing a normal auxiliary power source voltage characteristic during cranking;

FIG. 9B is a graph showing a degraded or abnormal auxiliary power source voltage characteristic during cranking;

FIG. 10 is a flowchart showing an example of communication abnormality determination process in the shift-by-wire ECU in FIG. 2;

FIG. 11 is a flowchart showing an example of discharge abnormality determination process in the shift-by-wire ECU in FIG. 2;

FIG. 12 is a flowchart showing an example of abnormality determination process in a transmission ECU in FIG. 2;

FIG. 13 is a time chart showing an example of operation of the shift-by-wire control system according to the embodiment of the present invention;

FIG. 14 is a time chart showing an example of operation other than shown in FIG. 13; and

FIG. 15 is a time chart showing an example of operation other than shown in FIG. 13 and FIG. 14.

### DETAILED DESCRIPTION OF THE INVENTION

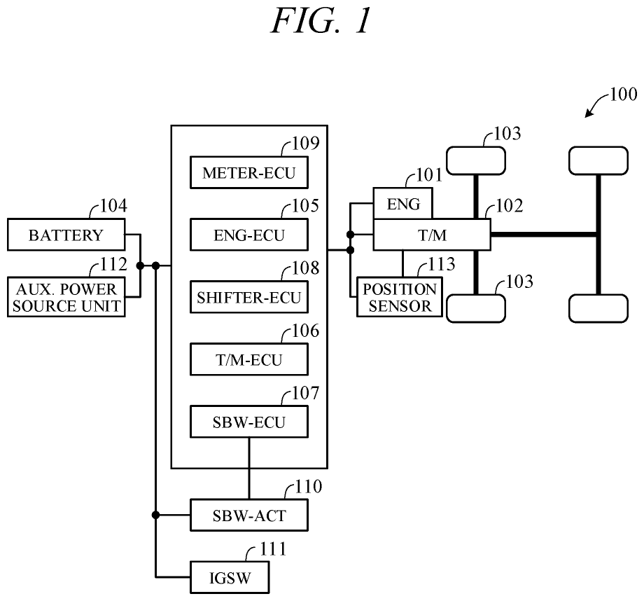

Now, an embodiment of the present invention will be described with reference to FIG. 1 to FIG. 15. FIG. 1 is a diagram schematically showing the configuration of main components of a vehicle 100 on which a shift-by-wire control system 1 according to the embodiment of the present invention is mounted. This shift-by-wire control system is configured to shift or change the speed range using electrical signals generated in response to the operator's manipulation. Note that FIG. 1 summarizes a schematic configuration of the vehicle 100 and power paths on the vehicle 100.

As shown in FIG. 1, the vehicle 100 on which the shift-by-wire control system 1 according to the present embodiment is mounted includes an engine (ENG) 101 mounted on a front portion of the vehicle and an automatic transmission (T/M) 102 coupled to the crankshaft of the engine 101. The vehicle 100 is a front-wheel drive vehicle, in which rotation outputted from the engine 101 is speed-changed by the automatic transmission 102 and drives front wheels 103. The vehicle on which the shift-by-wire control system 1 is mounted is not limited to a front-wheel drive vehicle and may be a rear-wheel drive vehicle or four-wheel drive vehicle.

The automatic transmission 102 coupled to the engine 101 shifts or changes the speed range, for example, by switching the oil passage using a manual valve, on-off solenoid valve, linear solenoid valve, shift valve, or the like and engaging a predetermined friction engagement element.

A battery 104 serving as the main power source of the vehicle 100 is connected to various ECUs, such as an engine ECU (ENG-ECU) 105, a transmission ECU (T/M-ECU) 106, a shift-by-wire ECU (SBW-ECU) 107, a shifter ECU (SHIFTER-ECU) 108, and a meter ECU (METER-ECU) 109, a shift-by-wire actuator (SBW-ACT) 110 for shifting the speed range, an ignition switch (IGSW) 111, and an auxiliary power source unit 112 so that it supplies power to these components.

For example, the battery 104 consists of a 12V lead battery and supplies 12V power to the components. The shift-by-wire ECU 107 constitutes a drive control unit for controlling drive of the shift-by-wire actuator 110.

The auxiliary power source unit 112 always receives supply of power from the battery 104 and thus is charged. The auxiliary power source unit 112 is configured to be able to always supply power to the ignition switch 111. The auxiliary power source unit 112 is also configured to, when an abnormality occurs in power supply from the battery 104, be able to supply power to the shift-by-wire ECU 107 and shift-by-wire actuator 110.

The ignition switch 111 is connected to the engine ECU 105, transmission ECU 106, shift-by-wire ECU 107, and meter ECU 109. The ignition switch 111 is configured to be able to output an ignition ON signal (IG ON signal) to these ECUs while receiving supply of power from the battery 104 or auxiliary power source unit 112.

A position sensor 113 is connected to the transmission ECU 106, shift-by-wire ECU 107, and meter ECU 109. The position sensor 113 detects the gear position or the speed range shifted or changed by the shift-by-wire actuator 110. The gear position includes multiple gear positions, such as a parking range P, a reverse range R, a neutral range N, and a drive range D. The shift-by-wire actuator 110 is driven by electrical signals generated in response to manipulation of a gear shift operation member, such as a lever or switch, by the operator.

The shifter ECU 108 converts, into a position signal, a shifter signal outputted in response to the operator's manipulation of a shift lever, shift button, or the like disposed on the vehicle 100 and transmits the position signal to the transmission ECU 106 through controller area network (CAN) communication. The transmission ECU 106 transmits a position request signal to the shift-by-wire ECU 107 through CAN communication on the basis of the position signal transmitted from the shifter ECU 108.

The shift-by-wire ECU 107 outputs control signals to the shift-by-wire actuator 110 on the basis of the position request signal transmitted from the transmission ECU 106. Thus, the shift-by-wire actuator 110 is driven, resulting in a shift in the speed range. The shifted speed range is detected by the position sensor 113 and recognized as the actual position by the transmission ECU 106 and shift-by-wire ECU 107.

The transmission ECU 106 transmits the recognized actual position to the engine ECU 105 and meter ECU 109 through CAN communication. Thus, the actual position is displayed on a meter, monitor, or the like of the vehicle 100 so that the operator can recognize the actual position.

The vehicle 100 is configured to be able to make local interconnect network (LIN) communication and thus to replace items that do not require a level of communication speed similar to that of CAN communication with cheap LIN communication.

In the vehicle 100 thus configured, an abnormality may occur in power supply from the battery 104 due to a voltage drop, wire break, contact failure, terminal disconnection, or the like of the battery 104 and thus the travel speed of the vehicle detected by a vehicle speed sensor may become equal to or smaller than a predetermined value. Also, the amount of power generated by an AC generator (not shown) may be reduced, making it difficult to operate the shift-by-wire ECU 107 and shift-by-wire actuator 110. In this case, the shift-by-wire control system 1 causes the auxiliary power source unit 112 to supply power to the shift-by-wire ECU 107 and shift-by-wire actuator 110. When the voltage supplied from the auxiliary power source unit 112 becomes equal to or smaller than a predetermined voltage, the shift-by-wire ECU 107, which has received supply of power from the auxiliary power source unit 112, drives the shift-by-wire actuator 110 to change the shift range of the vehicle 100 to the parking range.

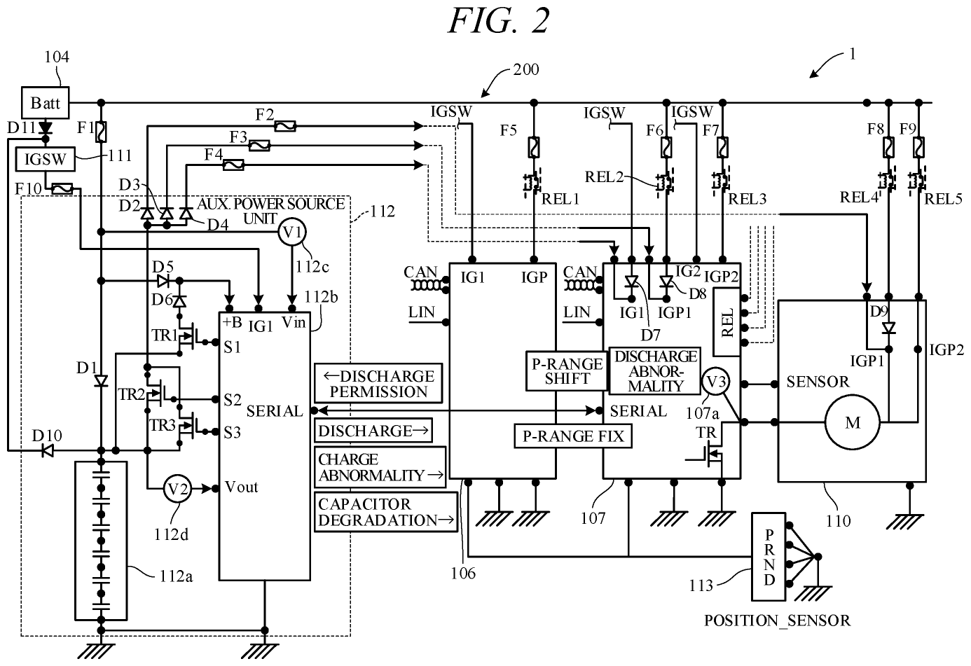

FIG. 2 is an electric circuit diagram schematically showing the configuration of main components of the shift-by-wire control system 1 according to the present embodiment.

As shown in FIG. 2, the electric circuit 200 of the shift-by-wire control system 1 includes the battery 104, auxiliary power source unit 112, shift-by-wire ECU 107, shift-by-wire actuator 110, and transmission ECU 106. The shift-by-wire ECU 107 serves as an abnormality determination unit that determines whether there is an abnormality in power supply from the battery 104.

The auxiliary power source unit 112 includes an auxiliary power source 112a and an auxiliary power source ECU 112b (auxiliary power source control unit). The auxiliary power source 112a includes multiple electrical double-layer capacitors that are always charged using power from the battery 104.

The auxiliary power source 112a including the electrical double-layer capacitors can be increased in life and improved in reliability compared to when the auxiliary power source 112a consists of a battery. Also, since the auxiliary power source 112a including the electrical double-layer capacitors is always connected to the battery 104, there is no need to dispose a complicated charge/discharge circuit, allowing the auxiliary power source 112a to be produced at low cost.

When the auxiliary power source ECU 112b determines that there is an abnormality in power supply from the battery 104 to the shift-by-wire ECU 107 and the travel speed of the vehicle detected by the vehicle speed sensor becomes equal to or smaller than the predetermined value, the auxiliary power source ECU 112b performs control so that power is supplied from the auxiliary power source 112a to the shift-by-wire ECU 107.

The battery 104 is connected to the ignition switch 111 through a backflow prevention diode D11 so that power is always supplied to the ignition switch 111.

The ignition switch 111 is connected to the IG1 terminal of the auxiliary power source ECU 112b through a fuse F10 so that, when turned on, it outputs the IG ON signal to the auxiliary power source ECU 112b. The ignition switch 111 is also connected to the IG1 terminal of the transmission ECU 106 and the IG1 terminal and IG2 terminal of the shift-by-wire ECU 107 so that, when turned on, it outputs the IG ON signal to these components. Note that the IG1 terminal of the shift-by-wire ECU 107 is connected to the ignition switch 111 through a backflow prevention diode D7.

The battery 104 is connected to the auxiliary power source 112a through the fuse F1 and backflow prevention diode D1, as well as is connected to the power source terminal (+B) of the auxiliary power source ECU 112b through the fuse F1 and a backflow prevention diode D5. Thus, the battery 104 is able to always supply power to the auxiliary power source 112a and the auxiliary power source ECU 112b, thereby placing the auxiliary power source 112a in a fully charged state using power from the battery 104.

The battery 104 is also connected to the IGP terminal of the transmission ECU 106 through a fuse F5 and a relay REL1. When the IG ON signal is inputted to the IG1 terminal of the transmission ECU 106, the relay REL1 is turned on and thus power is supplied from the battery 104 to the transmission ECU 106.

The battery 104 is also connected to the IGP1 terminal of the shift-by-wire ECU 107 through a fuse F6, a relay REL2, and a backflow prevention diode D8, as well as is connected to the IGP2 terminal of the shift-by-wire ECU 107 through a fuse F7 and a relay REL3. When the IG ON signal is inputted to the IGP1 terminal and IGP2 terminal of the shift-by-wire ECU 107, the relays REL2 and REL3 are turned on and thus power is supplied from the battery 104 to the shift-by-wire ECU 107.

The battery 104 is also connected to the IGP1 terminal of the shift-by-wire actuator 110 through a fuse F8 and a relay REL4, as well as is connected to the IGP2 terminal of the shift-by-wire actuator 110 through a fuse F9 and a relay REL5. The relays REL4 and REL5 of the shift-by-wire actuator 110 are turned on based on drive signals transmitted from the shift-by-wire ECU 107 and thus power is supplied from the battery 104 to the motor M of the shift-by-wire actuator 110.

The auxiliary power source 112a is connected to the ignition switch 111 through a backflow prevention diode D10 that prevents current flow from the battery 104 to the auxiliary power source 112a. Thus, when an abnormality occurs in power supply from the battery 104, the ignition-ON state can be maintained.

A first voltmeter 112c is connected to the Vin terminal of the auxiliary power source ECU 112b. The first voltmeter 112c measures an input voltage V1 inputted to the auxiliary power source unit 112 from the battery 104. A signal indicating the input voltage V1 is inputted to the auxiliary power source ECU 112b through the Vin terminal. A second voltmeter 112d is connected to the Vout terminal of the auxiliary power source ECU 112b. The second voltmeter 112d measures an output voltage V2 outputted from the auxiliary power source 112a. A signal indicating the output voltage V2 is inputted to the auxiliary power source ECU 112b through the Vout terminal.

The auxiliary power source 112a is connected to the power source terminal (+B terminal) of the auxiliary power source ECU 112b through a first switching circuit. When the first switching circuit is turned on, power is supplied from the auxiliary power source 112a to the auxiliary power source ECU 112b. The first switching circuit includes a transistor TR1 that is turned on and off in accordance with an S1 signal outputted from the S1 terminal of the auxiliary power source ECU 112b and a backflow prevention diode D6 that is disposed in series with the transistor TR1 and prevents current flow to the auxiliary power source 112a.

Since the auxiliary power source 112a is connected to the power source terminal (+B terminal) of the auxiliary power source ECU 112b through the first switching circuit, the auxiliary power source ECU 112b is connected to the auxiliary power source 112a only when the first switching circuit is turned on. Thus, the auxiliary power source 112a can be prevented from always supplying power to the auxiliary power source ECU 112b.

As a result, the shift-by-wire control system 1 is able to suppress useless consumption of power of the auxiliary power source 112a, as well as is able to prevent loss of power of the auxiliary power source 112a, for example, when the operator does not ride on the vehicle for a long time (does not drive the vehicle for a long time). Thus, when the ignition switch 111 of the vehicle 100 is turned on, the shift-by-wire control system 1 is able to prevent entry into a charge mode of the auxiliary power source 112a to compensate for a power shortage of the auxiliary power source 112a. As a result, the shift-by-wire control system 1 is able to handle an abnormality in power supply from the battery 104 when the ignition switch 111 is turned on. The shift-by-wire control system 1 is also able to prevent degradation of the auxiliary power source 112a due to an increase in the charge frequency and to prevent an erroneous determination that the auxiliary power source 112a has degraded.

Note that the first switching circuit may include a relay rather than the transistor TR1.

The auxiliary power source 112a is connected to the shift-by-wire ECU 107 and shift-by-wire actuator 110 through a second switching circuit, backflow prevention diode D2, D3, and D4, and fuses F2, F3, and F4. The second switching circuit includes a transistor TR2 that is turned on and off in accordance with an S2 signal outputted from the S2 terminal of the auxiliary power source ECU 112b and a transistor TR3 that is turned on and off in accordance with an S3 signal outputted from the S3 terminal of the auxiliary power source ECU 112b and is disposed in parallel with the transistor TR2.

Note that the second switching circuit may include relays rather than the transistors TR2 and TR3.

The auxiliary power source unit 112 and shift-by-wire ECU 107 are serially communicatively connected to each other. The shift-by-wire ECU 107 and transmission ECU 106 are configured to be able to communicate with the components of the vehicle 100 through CAN communication and LIN communication. For example, the transmission ECU 106 is able to read signals indicating the travel speed of the vehicle detected by the vehicle speed sensor (travel speed signals) through CAN communication.

A third voltmeter 107a is connected to the shift-by-wire ECU 107. The third voltmeter 107a measures a voltage V3 applied to the shift-by-wire actuator 110. In the shift-by-wire control system 1 thus configured, when the IG ON signal is inputted to the IG1 terminal of the shift-by-wire ECU 107 through the backflow prevention diode D7, the REL2 is turned on and power is supplied from the battery 104 to the shift-by-wire ECU 107 through the IGP1 terminal of the shift-by-wire ECU 107. Also, when the IG ON signal is inputted to the IG2 terminal of the shift-by-wire ECU 107, the relay REL3 is turned on and power is supplied from the battery 104 to the shift-by-wire ECU 107 through the IGP2 terminal of the shift-by-wire ECU 107.

The shift-by-wire ECU 107 determines whether there is an abnormality in power supply from the battery 104 due to a voltage drop, wire break, contact failure, terminal disconnection, or the like of the battery 104 on the basis of the voltage level inputted from the IGP1 terminal and the voltage level inputted from the IGP2 terminal (abnormality determination unit). If it determines that there is an abnormality in power supply, the shift-by-wire ECU 107 determines whether to permit the auxiliary power source unit 112 to discharge, on the basis of a travel speed signal read by the transmission ECU 106 through CAN communication. For example, if the auxiliary power source 112a has not discharged for a long time and the travel speed of the vehicle is equal to or smaller than the predetermined value, the shift-by-wire ECU 107 permits the auxiliary power source unit 112 to discharge by transmitting a discharge permission signal to the auxiliary power source unit 112 through serial communication.

The auxiliary power source ECU 112b of the auxiliary power source unit 112 receives the discharge permission signal transmitted from the shift-by-wire ECU 107 and determines whether there is an abnormality in power supply from the battery 104, on the basis of the input voltage V1 inputted to the auxiliary power source unit 112 and the output voltage V2 outputted from the auxiliary power source 112a. If it determines that there is an abnormality in power supply, the auxiliary power source ECU 112b performs control so that power is supplied from the auxiliary power source 112a to the auxiliary power source ECU 112b, as well as to the shift-by-wire ECU 107 and shift-by-wire actuator 110.

Specifically, the auxiliary power source ECU 112b outputs an S1 signal from the S1 terminal to turn on the transistor TR1 and outputs an S2 signal and an S3 signal from the S2 terminal and S3 terminal to turn on the transistor TR2 and transistor TR3. Thus, power is supplied from the auxiliary power source 112a to the auxiliary power source ECU 112b, shift-by-wire ECU 107, and shift-by-wire actuator 110. At this time, the auxiliary power source ECU 112b transmits a discharge signal to the shift-by-wire ECU 107 through serial communication.

The auxiliary power source unit 112 supplies power to the shift-by-wire ECU 107 and shift-by-wire actuator 110 through the backflow prevention diodes D2, D3, and D4. When the voltage of power from the auxiliary power source 112a and the battery 104 supplied through the IGP1 terminal and the IGP2 terminal becomes equal to or smaller than the predetermined voltage, the shift-by-wire ECU 107 drives the motor M of the shift-by-wire actuator 110 to shift or change the speed range to the parking range P.

The auxiliary power source ECU 112b determines whether the auxiliary power source 112a has a charge abnormality and whether the auxiliary power source 112a has degraded, on the basis of the input voltage V1 inputted to the auxiliary power source unit 112 and the output voltage V2 outputted from the auxiliary power source 112a. If it determines that the auxiliary power source 112a has charge abnormality, the auxiliary power source ECU 112b transmits a signal (charge abnormality signal) representing charge abnormality to the shift-by-wire ECU 107 through serial communication. If it determines that the auxiliary power source 112a has degraded, the auxiliary power source ECU 112b transmits a capacitor degradation signal to the shift-by-wire ECU 107 through serial communication.

The shift-by-wire ECU 107 receives the charge abnormality signal or the capacitor degradation signal and performs parking range fix process to fix or maintain the speed range in the parking range for a predetermined time period. At this time, even if the shift-by-wire ECU 107 receives a position request signal transmitted from the transmission ECU 106, it does not accept this input. The shift-by-wire ECU 107 also transmits abnormality signals representing charge abnormality and capacitor degradation through CAN communication so that abnormality information is displayed on a meter or the like.

The shift-by-wire ECU 107 also determines whether there is an abnormality, such as a wire break or short circuit, in the power supply line from the auxiliary power source unit 112, on the basis of the voltage of power supplied through the IG1 terminal, the voltage of power supplied through the IGP2 terminal, and the voltage outputted through a transistor TR constituting the drive switch of the motor M of the shift-by-wire actuator 110. If it determines that there is an abnormality, the shift-by-wire ECU 107 transmits an abnormality signal representing discharge abnormality through CAN communication so that abnormality information is displayed on a meter or the like.

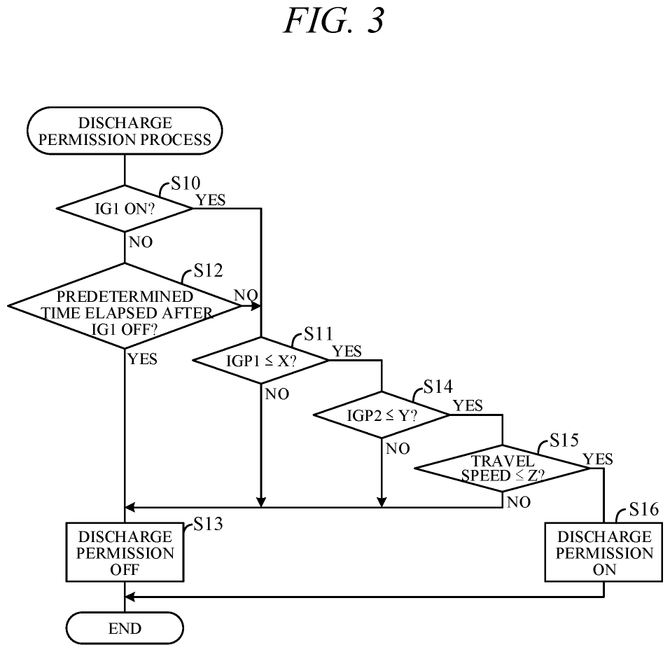

Next, the operation of the components of the shift-by-wire control system 1 thus configured will be described more specifically with reference to FIG. 3 to FIG. 15.

FIG. 3 is a flowchart showing an example of a process in which the shift-by-wire ECU 107 outputs the discharge permission signal (discharge permission process). For example, the process shown in this flowchart is started when the power switch of the vehicle 100 is turned on, and repeated in a predetermined cycle.

As shown in FIG. 3, first, in S10 (S: process step), the shift-by-wire ECU 107 determines whether the IG ON signal has been inputted to the IG1 terminal thereof. If the determination in S10 is YES, the process proceeds to S11; if the determination in S10 is NO, the process proceeds to S12. In S12, the shift-by-wire ECU 107 determines whether a predetermined time period (e.g., 12 seconds) has elapsed after turn-off of the ignition switch 111. If the determination in S12 is NO, the process proceeds to S11; if the determination in S12 is YES, the process proceeds to S13. In S13, the shift-by-wire ECU 107 turns off the discharge permission signal, ending the process.

In S11, the shift-by-wire ECU 107 determines whether the voltage supplied to the shift-by-wire ECU 107 from the battery 104 through the IGP1 terminal is equal to or smaller than a predetermined value X (e.g., 9V). If the determination in S11 is NO, the process proceeds to S13; if the determination in S11 is YES, the process proceeds to S14. In S14, the shift-by-wire ECU 107 determines whether the voltage supplied to the shift-by-wire ECU 107 from the battery 104 through the IGP2 terminal is equal to or smaller than a predetermined value Y (e.g., 9V).

If the determination in S14 is NO, the process proceeds to S13; if the determination in S14 is YES, the process proceeds to S15. In S15, the shift-by-wire ECU 107 determines whether the travel speed of the vehicle read by the transmission ECU 106 through CAN communication is equal to or smaller than a predetermined value Z (e.g., 3 km/h). If the determination in S15 is NO, the process proceeds to S13; if the determination in S15 is YES, the process proceeds to S16. In S16, the shift-by-wire ECU 107 turns on the discharge permission signal and outputs the discharge permission signal to the auxiliary power source ECU 112b through serial communication.

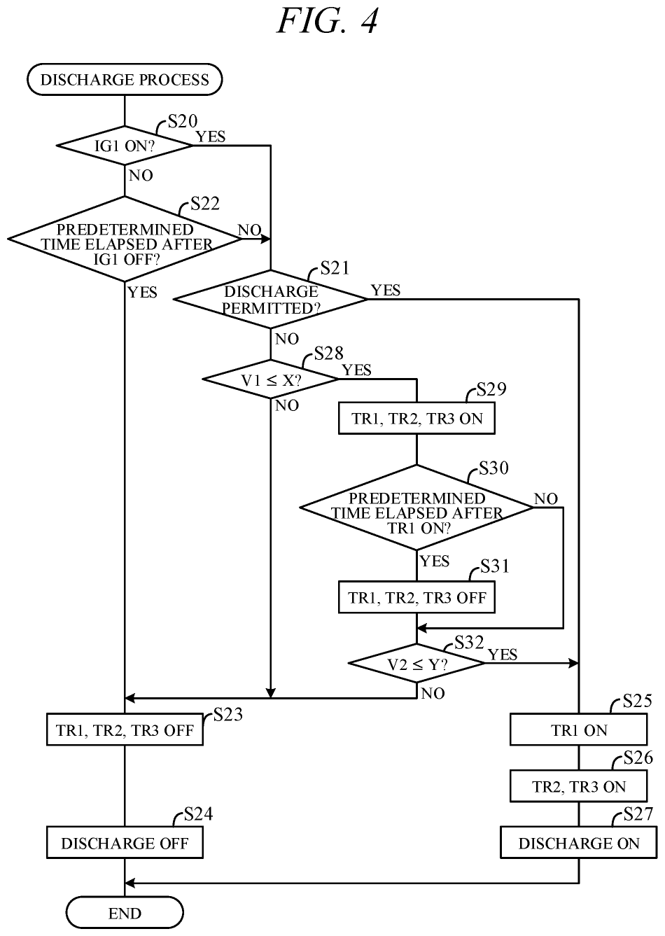

FIG. 4 is a flowchart showing an example of a process in which the auxiliary power source ECU 112b causes the auxiliary power source 112a to discharge (discharge process). For example, the process shown in this flowchart is started when the power switch of the vehicle 100 is turned on, and repeated in a predetermined cycle, as in FIG. 3.

As shown in FIG. 4, first, in S20, the auxiliary power source ECU 112b determines whether the IG ON signal has been inputted to the IG1 terminal thereof. If the determination in S20 is YES, the process proceeds to S21; if the determination in S20 is NO, the process proceeds to S22. In S22, the auxiliary power source ECU 112b determines whether a predetermined time period (e.g., 12 seconds) has elapsed after turn-off of the ignition switch 111.

If the determination in S22 is NO, the process proceeds to S21; if the determination in S22 is YES, the process proceeds to S23. In S23, the auxiliary power source ECU 112b turns off the transistors TR1, TR2, and TR3. Then, in S24, the auxiliary power source ECU 112b turns off the discharge signal, ending the process.

In S21, the auxiliary power source ECU 112b determines whether it has received the discharge permission signal outputted in the discharge permission process of FIG. 3. If the determination in S21 is YES, the process proceeds to S25 and the auxiliary power source ECU 112b turns on the transistor TR1. Thus, power is supplied from the auxiliary power source 112a to the auxiliary power source ECU 112b. Then, in S26, the auxiliary power source ECU 112b turns on the transistors TR2 and TR3. Thus, power is supplied from the auxiliary power source 112a to the shift-by-wire ECU 107 and shift-by-wire actuator 110. Then, in S27, the auxiliary power source ECU 112b turns on the discharge signal and outputs it to the shift-by-wire ECU 107 through serial communication.

On the other hand, if the determination in S21 is NO, the process proceeds to S28 and the auxiliary power source ECU 112b determines whether the input voltage V1 inputted thereto is equal to or smaller than the predetermined value X (e.g., 12V). If the determination in S28 is NO, the process proceeds to S23; if the determination in S28 is YES, the process proceeds to S29.

In S29, the auxiliary power source ECU 112b turns on the transistors TR1, TR2, and TR3. Then, in S30, the auxiliary power source ECU 112b determines whether a predetermined time period (e.g., 1 second) has elapsed after the turn-on of the transistor TR1. If the determination in S30 is YES, the process proceeds to S31; if the determination in S30 is NO, the process skips S31 and proceeds to S32. In S31, the auxiliary power source ECU 112b turns off the transistors TR1, TR2, and TR3 and the process proceeds to S32. By performing S29 to S31, the auxiliary power source ECU 112b is able to determine whether the voltage of the auxiliary power source 112a is normal during cranking of the engine based on a command from the shift-by-wire ECU 107.

In S32, the auxiliary power source ECU 112b determines whether the output voltage V2 outputted from the auxiliary power source 112a is equal to or smaller than the predetermined value Y (e.g., 9V). If the determination in S32 is YES, the process proceeds to S25; if the determination in S32 is NO, the process proceeds to S23.

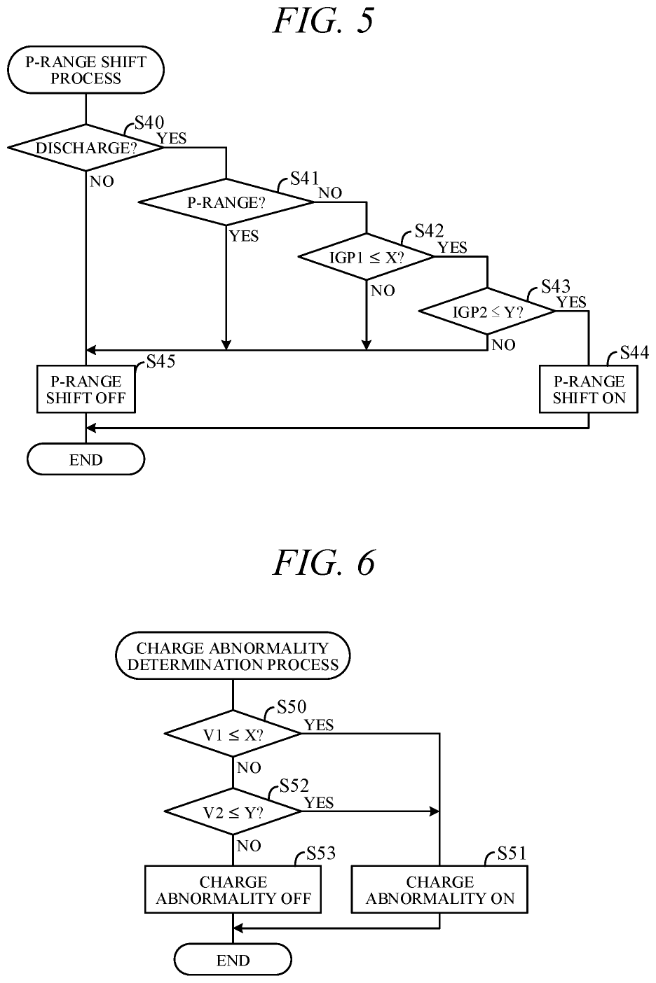

FIG. 5 is a flowchart showing an example of a process in which the shift-by-wire ECU 107 shifts or changes the gear position or the speed range to the parking range (parking range shift process). For example, the process shown in this flowchart is started when the power switch of the vehicle 100 is turned on, and repeated in a predetermined cycle.

As shown in FIG. 5, first, in S40, the shift-by-wire ECU 107 determines whether the auxiliary power source ECU 112b is outputting the discharge signal, that is, whether the shift-by-wire ECU 107 has received the discharge signal. If the determination in S40 is YES, the process proceeds to S41; if the determination in S40 is NO, the process proceeds to S45. In S45, the shift-by-wire ECU 107 turns off a parking range shift signal (parking range shift signal), ending the process. On the other hand, in S41, the shift-by-wire ECU 107 determines whether the speed range or the gear position detected by the position sensor 113 is the parking range P. If the determination in S41 is NO, the process proceeds to S42; if the determination in S41 is YES, the process proceeds to S45.

In S42, the shift-by-wire ECU 107 determines whether the voltage applied to the shift-by-wire ECU 107 by the battery 104 or the auxiliary power source 112a through the IGP1 terminal is equal to or smaller than the predetermined value X (e.g., 9V). If the determination in S42 is YES, the process proceeds to S43; if the determination in S42 is NO, the process proceeds to S45. In S43, the shift-by-wire ECU 107 determines whether the voltage applied to the shift-by-wire ECU 107 by the battery 104 through the IGP2 terminal is equal to or smaller than the predetermined value Y (e.g., 9V). If the determination in S43 is YES, the process proceeds to S44; if the determination in S43 is NO, the process proceeds to S45. In S44, the shift-by-wire ECU 107 turns on the parking range shift signal and drives the shift-by-wire actuator 110 to shift or change the gear position or the speed range to the parking range.

FIG. 6 is a flowchart showing an example of a process in which the auxiliary power source ECU 112b determines charge abnormality of the auxiliary power source 112a and outputs the charge abnormality signal representing charge abnormality of the auxiliary power source 112a (charge abnormality determination process). For example, the process shown in FIG. 6 is started when the auxiliary power source ECU 112b receives the IG ON signal outputted from the ignition switch 111, and repeated in a predetermined cycle.

As shown in FIG. 6, first, in S50, the auxiliary power source ECU 112b determines whether the input voltage V1 inputted thereto is equal to or smaller than the predetermined value X (e.g., 12V). If the determination in S50 is YES, the process proceeds to S51; if the determination in S50 is NO, the process proceeds to S52. In S51, the auxiliary power source ECU 112b turns on the charge abnormality signal, that is, transmits the charge abnormality signal to the shift-by-wire ECU 107 through serial communication, ending the process.

In S52, the auxiliary power source ECU 112b determines whether the output voltage V2 outputted from the auxiliary power source 112a is equal to or smaller than the predetermined value Y (e.g., 9V). If the determination in S52 is YES, the process proceeds to S51; if the determination in S52 is NO, the process proceeds to S53. In S53, the auxiliary power source ECU 112b turns off the charge abnormality signal, ending the process.

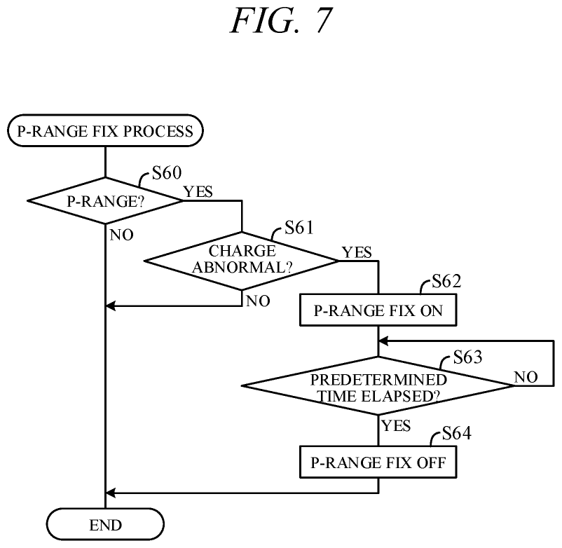

FIG. 7 is a flowchart showing an example of a process in which the shift-by-wire ECU 107 fixes or maintains the speed range in the parking range (parking range fix process). The process shown in FIG. 7 is started when the shift-by-wire ECU 107 receives the charge abnormality signal outputted from the auxiliary power source ECU 112b, and repeated in a predetermined cycle.

As shown in FIG. 7, first, in S60, the shift-by-wire ECU 107 determines whether the speed range detected by the position sensor 113 is the parking range P. If the determination in S60 is YES, the process proceeds to S61; if the determination in S60 is NO, the process ends. In S61, the shift-by-wire ECU 107 determines whether it has received the charge abnormality signal outputted from the auxiliary power source ECU 112b. If the determination in S61 is YES, the process proceeds to S62; if the determination in S61 is NO, the process ends. In S62, the shift-by-wire ECU 107 stops reception of any signal to request a position other than the parking range and fixes or maintains the gear position or the speed range in the parking range (turns on a parking range fix signal).

Then, in S63, the shift-by-wire ECU 107 determines whether a predetermined time period has elapsed. S63 is repeated until the determination becomes YES. When the determination in S63 becomes YES, the process proceeds to S64. In S64, the shift-by-wire ECU 107 turns off the parking range fix signal, ending the process.

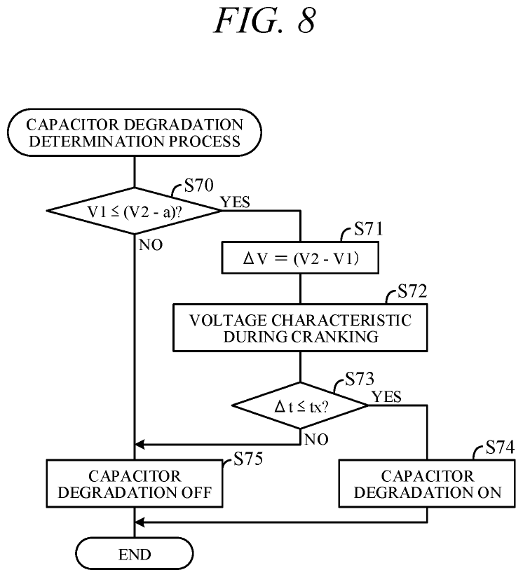

FIG. 8 is a flowchart showing an example of a process in which the auxiliary power source ECU 112b determines whether the capacitors of the auxiliary power source 112a have degraded (capacitor degradation determination process). For example, the process shown in FIG. 8 is started when the auxiliary power source ECU 112b receives the IG ON signal outputted from the ignition switch 111, and repeated in a predetermined cycle.

As shown in FIG. 8, first, in S70, the auxiliary power source ECU 112b determines whether the voltage V1 inputted to the auxiliary power source ECU 112b is equal to or smaller than a predetermined voltage. For example, the auxiliary power source ECU 112b determines whether the input voltage V1 is equal to or smaller than a value obtained by subtracting the voltage drop a (e.g., 1V) of the backflow prevention diode D1 from the output voltage V2. If the determination in S70 is NO, the process proceeds to S75. The auxiliary power source ECU 112b turns off the capacitor degradation signal, that is, ends the process without outputting the capacitor degradation signal.

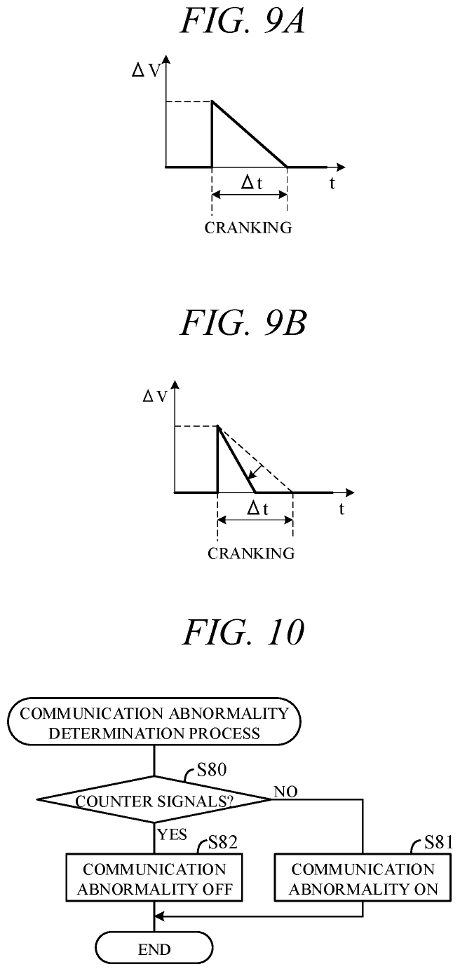

If the determination in S70 is YES, the auxiliary power source ECU 112b measures a voltage characteristic during engine cranking in S71 to S73. In this case, first, in S71, the auxiliary power source ECU 112b calculates the difference AV between the input voltage V1 and output voltage V2 as a voltage variation ΔV during cranking. Then, S72, the auxiliary power source ECU 112b obtains a voltage characteristic during cranking representing temporal changes in the voltage variation ΔV of the auxiliary power source 112a. FIG. 9A is a graph showing a voltage characteristic during cranking when the auxiliary power source 112a is in a normal state. FIG. 9B is a graph showing a voltage characteristic during cranking when the auxiliary power source 112a is in a degraded or abnormal state. As shown in FIG. 9A and FIG. 9B, time Δt required by the voltage variation ΔV is reduced in the degraded or abnormal state compared to in the normal state. In S73, the auxiliary power source ECU 112b determines whether the time Δt obtained on the basis of the characteristic of S72 is shorter than a predetermined time period tx. If the determination in S73 is YES, the process proceeds to S74; if the determination in S73 is NO, the process proceeds to S75. In S74, the auxiliary power source ECU 112b turns on the capacitor degradation signal, that is, outputs the capacitor degradation signal.

FIG. 10 is a flowchart showing an example of a process in which the shift-by-wire ECU 107 determines an abnormality in the serial communication line with the auxiliary power source ECU 112b (communication abnormality determination process). For example, the process shown in FIG. 10 is started when the shift-by-wire ECU 107 receives the IG ON signal outputted from the ignition switch 111, and repeated in a predetermined cycle.

As shown in FIG. 10, first, in S80, the shift-by-wire ECU 107 determines whether counter signals exist in the serial communication line between the auxiliary power source ECU 112b and shift-by-wire ECU 107 that always communicate with each other in a certain cycle. If the determination in S80 is NO, the shift-by-wire ECU 107, in 581, turns on an abnormality signal (communication abnormality signal) representing communication abnormality of the auxiliary power source unit 112, that is, outputs the communication abnormality signal through CAN communication, ending the process. In this case, the shift-by-wire ECU 107 transmits the communication abnormality signal to the transmission ECU 106 through CAN communication. On the other hand, if the determination in S80 is YES, the shift-by-wire ECU 107, in S82, turns off the communication abnormality signal, that is, ends the process without outputting the communication abnormality signal through CAN communication.

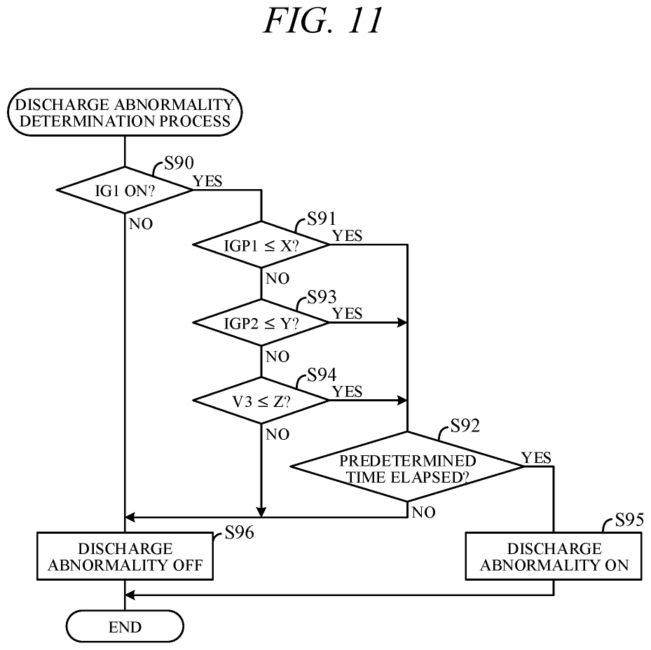

FIG. 11 is a flowchart showing an example of a process in which the shift-by-wire ECU 107 determines discharge abnormality of the auxiliary power source unit 112 and outputs an abnormality signal (discharge abnormality signal) indicating discharge abnormality of the auxiliary power source unit 112 through CAN communication when it determines that there is discharge abnormality of the auxiliary power source unit 112 due to a wire break, short-circuit, or the like of the power supply line (discharge abnormality determination process). For example, the process shown in FIG. 11 is started when the power switch of the vehicle 100 is turned on, and repeated in a predetermined cycle.

As shown in FIG. 11, first, in S90, the shift-by-wire ECU 107 determines whether the IG ON signal has been inputted to the IG1 terminal thereof. If the determination in S90 is YES, the process proceeds to S91; if the determination in S90 is NO, the process proceeds to S96. In S96, the shift-by-wire ECU 107 turns off the discharge abnormality signal, ending the process. On the other hand, in S91, the shift-by-wire ECU 107 determines whether the voltage inputted to the shift-by-wire ECU 107 through the IG1 terminal is equal to or smaller than the predetermined value X (e.g., 9V).

If the determination in S91 is YES, the process proceeds to S92; if the determination in S91 is NO, the process proceeds to S93. In S93, the shift-by-wire ECU 107 determines whether the voltage inputted to the shift-by-wire ECU 107 from the battery 104 through the IGP2 terminal is equal to or smaller than the predetermined value Y (e.g., 9V). If the determination in S93 is YES, the process proceeds to S92; if the determination in S93 is NO, the process proceeds to S94. In S94, the shift-by-wire ECU 107 determines whether the voltage V3 of the third voltmeter 107a connected to the shift-by-wire ECU 107 is equal to or smaller than the predetermined value Z (e.g., several mV).

If the determination in S94 is YES, the process proceeds to S92; if the determination in S94 is NO, the process proceeds to S96. In S92, the shift-by-wire ECU 107 determines whether a predetermined time period (e.g., 1 second) has elapsed after affirmed in S91, S93, or S94. If the determination in S92 is YES, the process proceeds to S95; if the determination in S92 is NO, the process proceeds to S96. In S95, the shift-by-wire ECU 107 turns on the discharge abnormality signal, that is, outputs the discharge abnormality signal through CAN communication. Thus, abnormality information is displayed on a meter or the like.

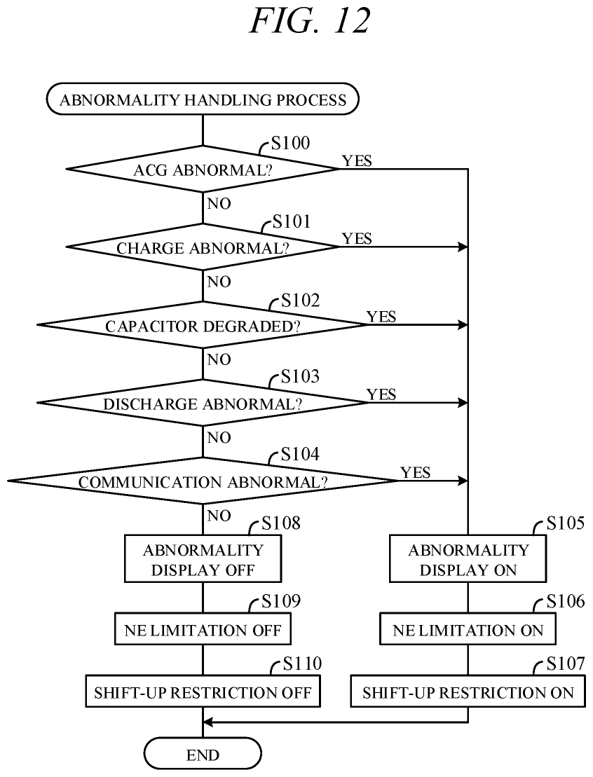

FIG. 12 is a flowchart showing an example of a process performed by the transmission ECU 106 when the AC generator is in an abnormal state or a signal failure occurs (abnormality handling process). For example, the process shown in FIG. 12 is started when the transmission ECU 106 receives the IG ON signal outputted from the ignition switch 111, and repeated in a predetermined cycle.

As shown in FIG. 12, first, in S100, the transmission ECU 106 determines whether the AC generator (not shown) of the vehicle 100 is in an abnormal state. If the determination in S100 is YES, the process proceeds to S105; if the determination in S100 is NO, the process proceeds to S101. In S101, the transmission ECU 106 determines whether the abnormality signal representing charge abnormality of the auxiliary power source 112a has been outputted in the process of FIG. 6, that is, the transmission ECU 106 has received the abnormality signal representing charge abnormality through CAN communication.

If the determination in S101 is YES, the process proceeds to S105; if the determination in S101 is NO, the process proceeds to S102. In S102, the transmission ECU 106 determines whether the abnormality signal representing capacitor degradation of the auxiliary power source 112a has been outputted in the process of FIG. 8, that is, the transmission ECU 106 has received the abnormality signal representing capacitor degradation through CAN communication. If the determination in S102 is YES, the process proceeds to S105; if the determination in S102 is NO, the process proceeds to S103. In S103, the transmission ECU 106 determines whether the abnormality signal representing discharge abnormality of the auxiliary power source unit 112 has been outputted in the process of FIG. 11, that is, the transmission ECU 106 has received the abnormality signal representing discharge abnormality through CAN communication. If the determination in S103 is YES, the process proceeds to S105; if the determination in S103 is NO, the process proceeds to S104. In S104, the transmission ECU 106 determines whether the abnormality signal representing communication abnormality of the auxiliary power source unit 112 has been outputted in the process of FIG. 10, that is, the transmission ECU 106 has received the abnormality signal representing communication abnormality through CAN communication. If the determination in S104 is YES, the process proceeds to S105; if the determination in S104 is NO, the process proceeds to S108.

In S105, the transmission ECU 106 transmits a signal to display the abnormality (abnormality display signal) through CAN communication. Thus, abnormality information is displayed on a meter or dedicated monitor. Then, in S106, the transmission ECU 106 transmits an engine speed limitation signal to limit the engine speed Ne to a predetermined value X (e.g., 2000 rpm) or less through CAN communication (Ne limitation). The engine ECU 105 receives the engine speed limitation signal, and the engine speed Ne is limited to the predetermined value X or less on the basis of a command from the engine ECU 105. Then, in S107, the transmission ECU 106 transmits a speed range limitation signal (shift-up restriction signal) to limit the speed range or the gear position to a predetermined value Y (e.g., the second gear) or less through CAN communication (shift-up restriction), ending the process. The gear position is limited to the predetermined value Y or less on the basis of a command from the transmission ECU 106.

On the other hand, in S108, the transmission ECU 106 cancels or turns off the abnormality display signal. Then, in S109, the transmission ECU 106 cancels or turns off the engine speed limitation signal (Ne limitation signal). In S110, the transmission ECU 106 cancels or turns off the speed range limitation signal (shift-up restriction signal), ending the process.

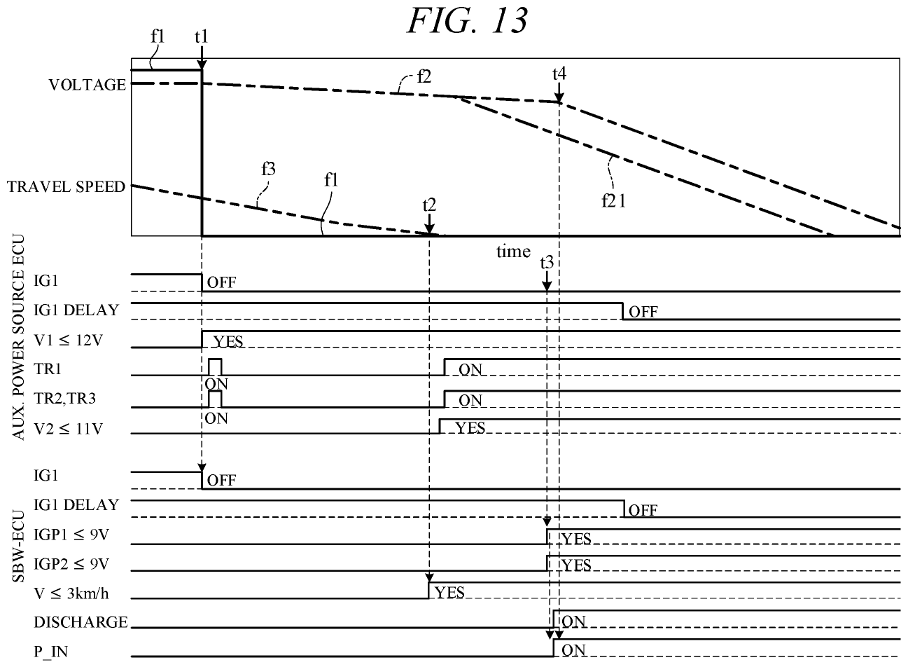

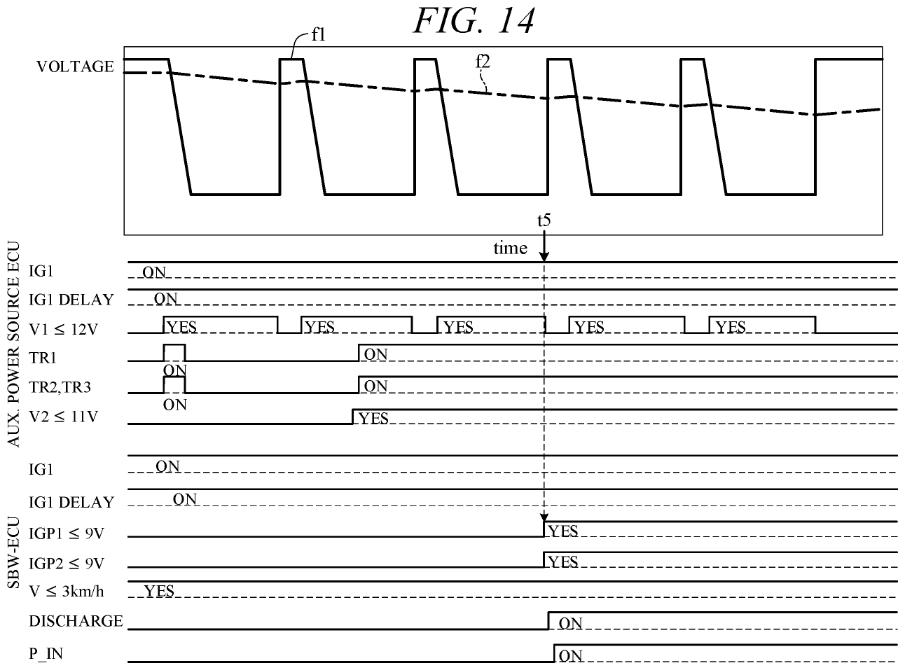

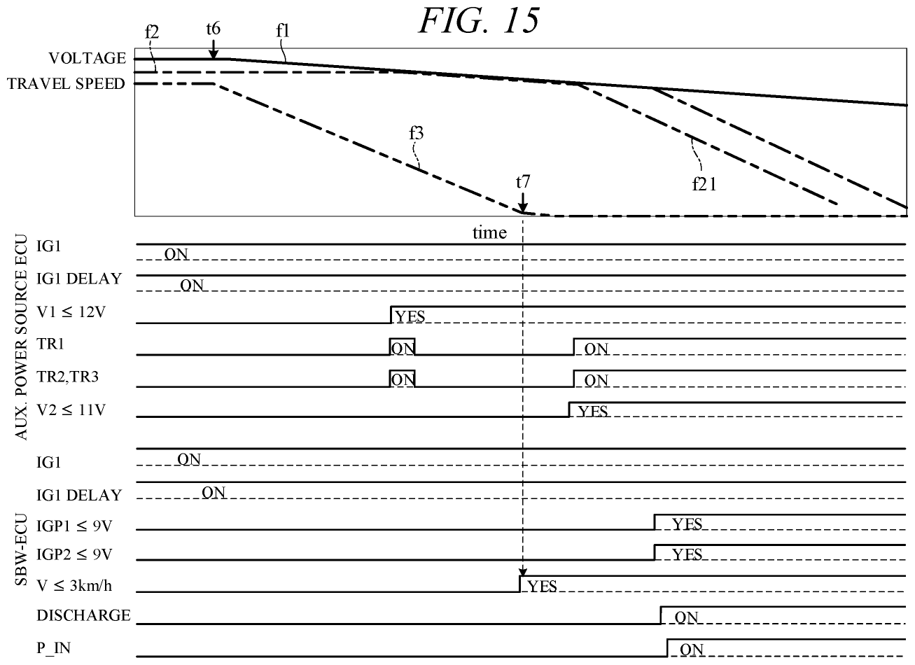

FIG. 13 to FIG. 15 are time charts showing an example of the operation of the shift-by-wire control system 1 according to the present embodiment, and these time charts represent operations corresponding to the processes of FIG. 3 to FIG. 5. Note that FIG. 13 represents operations when a terminal disconnection occurs in the battery 104; FIG. 14 represents operations when the engine starts; and FIG. 15 represents operations when the AC generator fails. In these diagrams, a characteristic f1 (solid line) represents changes in the voltage of the battery 104, a characteristic f2 (dash-dotted line) represents changes in the output voltage V3 with respect to the shift-by-wire actuator 110, and a characteristic f3 (dash-dot-dot line) represents changes in the travel speed of the vehicle. Note that a characteristic f21 in FIG. 13 and FIG. 15 is a characteristic when the speed range is shifted to the parking range in response to the output voltage V2 becoming equal to or smaller than 11 V.

As shown in FIG. 13, at time t1, a terminal disconnection occurs in the battery 104, and the engine stops and the AC generator is disabled from generating power. Δt this time, the signal to the IG1 terminal of the auxiliary power source ECU 112b and the IG1 terminal of the shift-by-wire ECU 107 is turned off. Then, at time t2, the travel speed of the vehicle becomes equal to or smaller than 3 km/h, and the transistors TR1, TR2, and TR3 are turned on. Further, at time t3, the voltage supplied through the IGP1 terminal and IGP2 terminal of the shift-by-wire ECU 107 becomes equal to or smaller than 9V, and the shift-by-wire actuator 110 is activated to shift or change the speed range to the parking range. Thus, the decreasing gradient of the output voltage V3 is increased (characteristic f2). Note that when a predetermined time period (e.g., 12 seconds) elapses after the turn-off of IG1, the discharge permission signal is turned off (IG1 DELAY).

In FIG. 14, at time t5, the input voltage V1 of the auxiliary power source ECU 112b becomes equal to or smaller than the predetermined value, and the voltage supplied through the IGP1 terminal and IGP2 terminal of the shift-by-wire ECU 107 becomes equal to or smaller than 9V. Thus, the parking range shift signal is outputted. Note that the speed range at the start of the engine (during cranking) is the parking range and therefore the shift-by-wire actuator 110 is nonoperational, resulting in a small reduction in the output voltage V3. In FIG. 15, the AC generator fails at time t6, and failure information is displayed until time t7, at which the travel speed of the vehicle becomes equal to or smaller than 3 km/h.

The present embodiment can achieve advantages and effects such as the following:

(1) The shift-by-wire control system 1 includes: the shift-by-wire actuator 110 driven by electric signals generated in response to operator's manipulation to change the speed range; the shift-by-wire ECU 107 configured to control the shift-by-wire actuator 110; the battery 104 (main power source) and the auxiliary power source 112a constituting a power source configured to supply power to the shift-by-wire ECU 107 through the electric circuit 200; the transmission ECU 106 as an information acquisition unit configured to acquire the travel speed information; and the shift-by-wire ECU 107 and the auxiliary power source ECU 112b as a power control unit configured to control power supply from the power source to the shift-by-wire ECU 107 (FIG. 2). The shift-by-wire ECU 107 includes a determination unit configured to determine whether a main power supply from the battery 104 to the shift-by-wire ECU 107 is abnormal and whether the travel speed acquired by the transmission ECU 106 is equal to or lower than the predetermined value Z (FIG. 3). The shift-by-wire ECU 107 and the auxiliary power source ECU 112b are configured to control the electric circuit 200 (transistors TR1, TR2, TR3) to stop an auxiliary power supply from the auxiliary power source 112a to the shift-by-wire ECU 107 until it is determined by the determination unit that the main power supply is abnormal and the travel speed is equal to or lower than the predetermined value Z, and to control the electric circuit 200 to supply power from the auxiliary power source 112a to the shift-by-wire ECU 107 when it is determined by the determination unit that the main power supply is abnormal and the travel speed is equal to or lower than the predetermined value Z (FIG. 3, FIG. 4). The determination unit is further configured to determine whether the output voltage from the auxiliary power source 112a is equal to or lower than the predetermined value X (FIG. 5). The shift-by-wire ECU 107 is configured to control the shift-by-wire actuator 110 to change the speed range to the parking range when it is determined by the determination unit that the output voltage from the auxiliary power source 112a is equal to or lower than the predetermined value X during the auxiliary power supply from the auxiliary power source 112a to the shift-by-wire ECU 107 (FIG. 5).

With this configuration, the redundancy of the shift-by-wire control system can be further improved. Specifically, the shift-by-wire control system 1 is able to suppress useless power consumption of the auxiliary power source 112a. It is also able to prevent an insufficient charge of the auxiliary power source 112a, for example, if the operator does not ride on the vehicle for a long time. Thus, when the ignition switch 111 of the vehicle 100 is turned on, the shift-by-wire control system 1 is able to prevent the auxiliary power source 112a from entering charge mode to resolve an insufficient charge. As a result, the shift-by-wire control system 1 is able to easily handle an abnormality in power supply from the battery 104 when the ignition switch 111 is turned on and to prevent degradation of the auxiliary power source 112a due to an increase in the charge frequency. It is also able to prevent an erroneous determination that the auxiliary power source 112a has degraded.

Further, when the voltage supplied from the auxiliary power source 112a becomes equal to or smaller than the predetermined voltage, the shift-by-wire control system 1 shifts the speed range to the parking range and thus is able to properly handle an abnormality in the battery 104.

(2) The auxiliary power source 112a includes a plurality of electric double layer capacitors (FIG. 2). With this, it becomes possible to increase system life and improve system reliability compared to those including a battery as an auxiliary power source and to reliably ensure a vehicle parking function when the battery is dead or the power supply line from the battery is broken.

(3) The auxiliary power source 112a is connected to the ignition switch 111 connected to the battery 104 and configured to be able to supply power to the ignition switch 111 (FIG. 2). With this, it becomes possible to output an IG ON signal from the ignition switch 111 on the basis of power from the auxiliary power source 112a even when abnormality occurs in power supply from the battery 104. As a result, it becomes possible to turn on the transistors TR1, TR2, and TR3 on the basis of the signal from the auxiliary power source ECU 112b to supply power from the auxiliary power source 112a to the auxiliary power source ECU 112b and the shift-by-wire ECU 107.

(4) The auxiliary power source ECU 112b is configured to determine whether the input voltage V1 to the auxiliary power source 112a is equal to or lower than the first predetermined value X (for example, 12V), and to determine whether the output voltage V2 from the auxiliary power source 112a is equal to or lower than the second predetermined value Y (for example, 9V) lower than the first predetermined value X (FIG. 6). The shift-by-wire ECU 107 is configured to control the shift-by-wire actuator 110 to maintain the speed range in the parking range for a predetermined time period when it is determined by the auxiliary power source ECU 112b that the input voltage V1 is equal to or lower than the first predetermined value X (V1≤X) or the output voltage V2 is equal to or lower than the second predetermined value Y (V2≤Y), i.e., when receiving the charge abnormality signal, during the auxiliary power supply from the auxiliary power source 112a to the shift-by-wire ECU 107 (FIG. 7).

With this, it becomes possible to reliably determine whether a charge abnormality has occurred in the auxiliary power source 112a and to properly handle the charge abnormality of the auxiliary power source 112a.

In the above embodiment, although the speed range is shifted or changed by driving the motor of the shift-by-wire actuator 110, an actuator for changing speed range need not be the motor. In the above embodiment, although the shift-by-wire ECU 107 controls the shift-by-wire actuator 110, an actuator control unit or actuator control circuit need not be configured as described above. In the above embodiment, although power is supplied from the battery 104 and the auxiliary power source 112a to the shift-by-wire ECU 107 through the electric circuit 200, an electric circuit connecting the power source and the actuator control unit need not be configured as described above. In the above embodiment, although the transmission ECU 106 reads information about the travel speed of the vehicle through CAN communication, an information acquisition unit need not be configured as described above.

In the above embodiment, although the auxiliary power source ECU 112b controls power supply from the auxiliary power source 112a to the shift-by-wire ECU 107, a power control unit for controlling power supply from the power source to the actuator control unit need not be configured as described above. That is, the power control unit may have any configuration as long as: the power control unit includes a determination unit that determines whether there is an abnormality in power supply from the battery 104 to the shift-by-wire ECU 107 and also determines whether the travel speed of the vehicle is equal to or smaller than the predetermined value Z; the power control unit blocks power supply from the auxiliary power source 112a until the determination unit determines that there is an abnormality in the power supply from the battery 104 and that the travel speed of the vehicle is equal to or smaller than the predetermined value Z; and the power control unit controls the electric circuit 200 so that power is supplied from the auxiliary power source 112a to the shift-by-wire ECU 107 when the determination unit determines that there is an abnormality in the power supply from the battery 104 and that the travel speed of the vehicle is equal to or smaller than the predetermined value Z. In the above embodiment, although the speed range is shifted or changed to the parking range when it is determined that the voltage outputted from the auxiliary power source 112a has become the predetermined value X while power is supplied from the auxiliary power source 112a to the shift-by-wire ECU 107, an actuator control unit need not be configured as described above.

In the above embodiment, although the electric circuit 200 includes the transistor TR1 (first switch) that connects and disconnects the auxiliary power source 112a and auxiliary power source ECU 112b and the transistors TR2 and TR3 (second switch) that connect and disconnect the auxiliary power source 112a and shift-by-wire ECU 107, an electric circuit need not be configured as described above. In the above embodiment, although the shift-by-wire ECU 107 (first ECU) and the auxiliary power source ECU 112b (second ECU) are connected through serial communication and the transmission ECU 106 (third ECU) and the shift-by-wire ECU 107 are connected through CAN communication, the number of ECUs or the connection form is not limited to that described above.

The present invention may also be used as a shift-by-wire control method for controlling shifting operation of a vehicle including: an actuator driven by electric signals generated in response to operator's manipulation to change a speed range; a power source including a main power source and an auxiliary power source; and an electric circuit connecting the power source and the actuator. In this case, the electric circuit includes an actuator control circuit that controls the actuator. The shift-by-wire control method includes: controlling the actuator; acquiring vehicle travel speed information; and controlling power supply from the power source to the actuator control circuit. The power supply controlling includes: determining whether a main power supply from the main power source to the actuator control circuit is abnormal and whether the travel speed is equal to or lower than a predetermined speed; controlling the electric circuit to stop an auxiliary power supply from the auxiliary power source to the actuator control circuit until it is determined that the main power supply is abnormal and the travel speed is equal to or lower than the predetermined speed; and controlling the electric circuit to supply power from the auxiliary power source to the actuator control circuit when it is determined that the main power supply is abnormal and the travel speed is equal to or lower than the predetermined speed. The actuator controlling includes: determining whether an output voltage from the auxiliary power source is equal to or lower than a predetermined voltage; and controlling the actuator to change the speed range to a parking range when it is determined that the output voltage from the auxiliary power source is equal to or lower than the predetermined voltage during the auxiliary power supply.

The above embodiment can be combined as desired with one or more of the above modifications. The modifications can also be combined with one another.

According to the present invention, it becomes possible to provide shift-by-wire control system improved in terms of redundancy.

Above, while the present invention has been described with reference to the preferred embodiments thereof, it will be understood, by those skilled in the art, that various changes and modifications may be made thereto without departing from the scope of the appended claims.

What is claimed is:

1. A shift-by-wire control system, comprising:
an actuator driven by electric signals generated in response to operator's manipulation to change a speed range;
a power source including a main power source and an auxiliary power source;
an electronic control unit including a microprocessor and a memory coupled to the microprocessor; and
an electric circuit connecting the power source and the electronic control unit, wherein
the microprocessor is configured to perform:
acquiring travel speed information of the vehicle;
determining whether a main power supply from the main power source to the electronic control unit is abnormal and whether the travel speed is equal to or lower than a predetermined speed;
controlling the electric circuit to stop an auxiliary power supply from the auxiliary power source to the electronic control unit until it is determined that the main power supply is abnormal and the travel speed is equal to or lower than the predetermined speed;
controlling the electric circuit to supply power from the auxiliary power source to the electronic control unit when it is determined that the main power supply is abnormal and the travel speed is equal to or lower than the predetermined speed;
determining whether an output voltage from the auxiliary power source is equal to or lower than a predetermined voltage; and
controlling the actuator to change the speed range to a parking range when it is determined that the output voltage from the auxiliary power source is equal to or lower than the predetermined voltage during the auxiliary power supply.

2. The shift-by-wire control system according to claim 1, wherein
the auxiliary power source includes a plurality of electric double layer capacitors.

3. The shift-by-wire control system according to claim 1, wherein
the auxiliary power source is connected to an ignition switch connected to the main power source and configured to be able to supply power to the ignition switch.

4. The shift-by-wire control system according to claim 1, wherein
the microprocessor is configured to perform:
determining whether an input voltage to the auxiliary power source is equal to or lower than a first voltage;
determining whether the output voltage from the auxiliary power source is equal to or lower than a second voltage lower than the first voltage, and
controlling the actuator to maintain the speed range in the parking range for a predetermined time period when it is determined that the input voltage to the auxiliary power source is equal to or lower than the first voltage or the output voltage from the auxiliary power source is equal to or lower than the second voltage during the auxiliary power supply.

5. The shift-by-wire control system according to claim 1, wherein
the electronic control unit includes:
an actuator control unit configured to control the actuator; and
a power control unit configured to control power supply from the power source to the actuator control unit, wherein
the electric circuit includes a switch connecting and disconnecting the auxiliary power source and the power control unit, wherein
the microprocessor is configured to perform:
controlling the switch to disconnect the auxiliary power source and the power control unit until it is determined that the main power supply is abnormal and the travel speed is equal to or lower than the predetermined speed; and
controlling the switch to connect the auxiliary power source and the power control unit when it is determined that the main power supply is abnormal and the travel speed is equal to or lower than the predetermined speed.

6. The shift-by-wire control system according to claim 5, wherein
the switch is a first switch, wherein
the electric circuit further includes a second switch connecting and disconnecting the auxiliary power source and the actuator control unit, wherein
the microprocessor is configured to perform:
controlling the second switch to disconnect the auxiliary power source and the actuator control unit until it is determined that the main power supply is abnormal and the travel speed is equal to or lower than the predetermined speed; and
controlling the second switch to connect the auxiliary power source and the actuator control unit when it is determined that the main power supply is abnormal and the travel speed is equal to or lower than the predetermined speed.

7. The shift-by-wire control system according to claim 1, wherein
the electronic control unit includes:
a first ECU configured to control the actuator;
a second ECU connected to the first ECU through serial communication; and
a third ECU configured to read signals indicating the travel speed through CAN communication and connected to the first ECU.

8. A shift-by-wire control system, comprising:
an actuator driven by electric signals generated in response to operator's manipulation to change a speed range;
a power source including a main power source and an auxiliary power source;
an electronic control unit including a microprocessor and a memory coupled to the microprocessor; and
an electric circuit connecting the power source and the electronic control unit, wherein
the microprocessor is configured to perform as:
an actuator control unit configured to control the actuator;
a power control unit configured to control power supply from the power source to the actuator control unit; and
an information acquisition unit configured to acquire travel speed information of the vehicle, wherein
the power control unit includes:
a determination unit configured to determine whether a main power supply from the main power source to the actuator control unit is abnormal and whether the travel speed acquired by the information acquisition unit is equal to or lower than a predetermined speed, wherein
the power control unit is configured to control the electric circuit to stop an auxiliary power supply from the auxiliary power source to the actuator control unit until it is determined by the determination unit that the main power supply is abnormal and the travel speed is equal to or lower than the predetermined speed, and to control the electric circuit to supply power from the auxiliary power source to the actuator control unit when it is determined by the determination unit that the main power supply is abnormal and the travel speed is equal to or lower than the predetermined speed, wherein
the determination unit is further configured to determine whether an output voltage from the auxiliary power source is equal to or lower than a predetermined voltage, wherein
the actuator control unit is configured to control the actuator to change the speed range to a parking range when it is determined by the determination unit that the output voltage from the auxiliary power source is equal to or lower than the predetermined voltage during the auxiliary power supply.

9. The shift-by-wire control system according to claim 8, wherein the auxiliary power source includes a plurality of electric double layer capacitors.

10. The shift-by-wire control system according to claim 8, wherein the auxiliary power source is connected to an ignition switch connected to the main power source and configured to be able to supply power to the ignition switch.

11. The shift-by-wire control system according to claim 8, wherein
the determination unit is further configured to determine whether an input voltage to the auxiliary power source is equal to or lower than a first voltage, and to determine whether the output voltage from the auxiliary power source is equal to or lower than a second voltage lower than the first voltage, wherein
the actuator control unit is configured to control the actuator to maintain the speed range in the parking range for a predetermined time period when it is determined by the determination unit that the input voltage to the auxiliary power source is equal to or lower than the first voltage or the output voltage from the auxiliary power source is equal to or lower than the second voltage during the auxiliary power supply.

12. The shift-by-wire control system according to claim 8, wherein
the electric circuit includes a switch connecting and disconnecting the auxiliary power source and the power control unit, wherein
the power control unit is configured to control the switch to disconnect the auxiliary power source and the power control unit until it is determined by the determination unit that the main power supply is abnormal and the travel speed is equal to or lower than the predetermined speed, and to control the switch to connect the auxiliary power source and the power control unit when it is determined by the determination unit that the main power supply is abnormal and the travel speed is equal to or lower than the predetermined speed.

13. The shift-by-wire control system according to claim 12, wherein
the switch is a first switch, wherein
the electric circuit further includes a second switch connecting and disconnecting the auxiliary power source and the actuator control unit, wherein
the power control unit is configured to control the second switch to disconnect the auxiliary power source and the actuator control unit until it is determined by the determination unit that the main power supply is abnormal and the travel speed is equal to or lower than the predetermined speed, and to control the second switch to connect the auxiliary power source and the actuator control unit when it is determined by the determination unit that the main power supply is abnormal and the travel speed is equal to or lower than the predetermined speed.

14. The shift-by-wire control system according to claim 8, wherein
the electronic control unit includes:
a first ECU configured to function as the actuator control unit;
a second ECU connected to the first ECU through serial communication and configured to function as the power control unit; and
a third ECU configured to read signals indicating the travel speed through CAN communication, connected to the first ECU, and configured to function as the information acquisition unit.

15. A shift-by-wire control method for controlling shifting operation of a vehicle including: an actuator driven by electric signals generated in response to operator's manipulation to change a speed range; a power source including a main power source and an auxiliary power source; and an electric circuit connecting the power source and the actuator, wherein
the electric circuit includes an actuator control circuit configured to control the actuator, wherein
the shift-by-wire control method comprises:
acquiring travel speed information of the vehicle;
determining whether a main power supply from the main power source to the actuator control circuit is abnormal and whether the travel speed is equal to or lower than a predetermined speed;
controlling the electric circuit to stop an auxiliary power supply from the auxiliary power source to the actuator control circuit until it is determined that the main power supply is abnormal and the travel speed is equal to or lower than the predetermined speed;
controlling the electric circuit to supply power from the auxiliary power source to the actuator control circuit when it is determined that the main power supply is abnormal and the travel speed is equal to or lower than the predetermined speed;
determining whether an output voltage from the auxiliary power source is equal to or lower than a predetermined voltage; and
controlling the actuator to change the speed range to a parking range when it is determined that the output voltage from the auxiliary power source is equal to or lower than the predetermined voltage during the auxiliary power supply.
